(19) United States
(12) Patent Application Publication
(10) Pub. No.: US 2017/0142646 A1
(43) Pub. Date: May 18, 2017

(54) HUNTING AND SCANNING ACROSS LMR AND IP NETWORKS

(71) Applicants: Niall McAndrew, Christchurch (NZ); Emma Patricia Caunter, Raglan (NZ); Clive Douglas Horn, Christchurch (NZ); Nick Clark, Christchurch (NZ)

(72) Inventors: Niall McAndrew, Christchurch (NZ); Emma Patricia Caunter, Raglan (NZ); Clive Douglas Horn, Christchurch (NZ); Nick Clark, Christchurch (NZ)

(21) Appl. No.: 15/350,332

(22) Filed: Nov. 14, 2016

(30) Foreign Application Priority Data
Nov. 13, 2015 (NZ) 714188

(51) Int. Cl. H04W 48/16; H04W 76/02; H04L 29/12

(52) U.S. Cl. CPC H04W 48/16; H04L 61/2007; H04W 76/02

(57) ABSTRACT

Integration of a Land Mobile Radio (LMR) communications system and other wireless IP based systems such as LTE by way of a multi bearer router. The LMR system may be either trunked or conventional. Undertaking hunting for trunked control channels such that the best site is connected. Undertaking scanning for traffic channels such that the best site is connected. Flexibility is provided by enabling a multi bearer terminal in the communication system to communicate by RF and/or IP based signals.

### CROSS-REFERENCE TO RELATED APPLICATIONS

This patent application claims the priority of New Zealand Provisional Patent Application No. NZ714188, filed Nov. 13, 2015, the disclosure of which is incorporated by reference in its entirety for all purposes.

### FIELD OF THE INVENTION

This invention relates to the integration of services between a Land mobile radio (LMR) communications system and other wireless technology such as cellular that can offer a multi-bearer terminal the relatively high data rates needed to support an Internet Protocol (IP) path. In particular the invention relates to architectures for conducting hunting and scanning in a multi-bearer system in either trunked or conventional LMR systems.

### BACKGROUND TO THE INVENTION

Public safety agencies around the world typically use relatively narrow band LMR technologies such as P25 to communicate voice information and low speed data traffic. Characteristics of this technology are long range and high quality voice. Today, public safety is also using new technologies, such as Long Term Evolution (LTE), capable of high data rates enabling mobile data applications. This form of technology is relatively short range compared to the narrowband technologies. In a move to capture the benefits of both technologies, methods of integration are being considered.

Typically, LMR systems are deployed over wide areas where public safety operation is expected, including both populated and unpopulated areas. Typically, cellular systems are deployed over populated areas, or areas where revenue can be generated through user traffic. There are areas where LMR exists but no cellular. There are areas where cellular exists but no LMR. There are areas where both LMR and cellular exist.

LMR systems typically exist in two forms. The first is referred to as “conventional”. In this configuration a radio channel is used by a group of terminal devices where the communication is conducted by a repeater that is typically located on a physically high site offering good geographic coverage. The user of the terminal will typically make a manual choice of channel number through choosing that channel via a selection knob on the terminal. Upon pressing a push-to-talk button on that terminal, the voice is then received by any other terminal that is configured to listen to that channel. In its simplest form, any terminal listening to the channel will unmute. This is one way of creating group communications. In another form, a receiving terminal will monitor a plurality of conventional channels to detect either calls for that group or to select the best channel upon which to receive the call. This is referred to as “scanning”.

In conventional communications, a talkgroup can also be created according to a group identity. The group identity is normally a specific number that identifies the group. This identity is sent along with the voice information and any terminal that is both listening to the channel and a member of this talkgroup will unmute. A conventional site typically contains a plurality of traffic channels.

Another form of system typically used in LMR is “trunked”. In this case, there is typically one control channel and several traffic channels. A trunked system is a centrally controlled network. All terminals not in a voice call will listen to the one or more control channels. This is referred to as “hunting”.

If a call is initiated to a talkgroup then the trunked terminals in said talkgroup are sent to a traffic channel. Any trunked terminal wishing to access the network must first register with the network. This represents a form of security to ensure the terminal is permitted on the network. Registration normally takes place at switch on of the terminal or when the terminal enters coverage of the control channel. All trunked terminals must register.

Following registration, all trunked terminals must identify which talkgroups they are a part of. This is required so that if a call for that group is initiated then all terminals in that group can be sent to the correct traffic channel. This group information (referred to as group affiliation) is knowledge held by the trunked controller.

Solutions are required that integrate LMR RF channels and IP capable bearers in such a way that a user is unaware of the communication bearer being used. In other words, the terminal always appears to function as a normal LMR radio whether in conventional or trunked operation.

Historically there have been innovations that selectively communicate calls over either cellular or LMR depending upon which bearer is available. Previous attempts to enable LMR across a cellular network generally selects between an LMR voice call, a normal cellular call or a Voice over IP (VoIP) call. In other words, the protocols for each path are different and only one path is chosen at any time. In some cases LMR is described in the context of tunnelling LMR information through an IP pipe. A key problem exists relating to hunting for both trunked operation and scanning in the case of conventional operation.

In the case of both hunting and scanning, the typical solution involves connecting to a site with the best signal level. NZ 711325 (US 20160057051) described in detail a multi-bearer system that operates across LMR channels and IP connected channels. That specification describes how a terminal equipped with both LMR and IP paths could receive or transmit LMR traffic by either path. Key to this operation is the association between the multi-bearer terminal and the IP address of the correct site. NZ 711325 describes a method of building a table of associations to ensure LMR traffic sent over an IP pipe is sent to the same base station as the Radio frequency (RF) path. A circuit mode LMR signal (ie the RF path) becomes a circuit mode LMR signal tunnelled in a packet mode IP pipe.

Operation occurs across LMR and IP capable channels. A first bearer is LMR and may be P25 (APCO 25), Terrestrial trunked radio (TETRA), Digital mobile radio (DMR) or generally any form of relatively narrow band protocol. The second bearer may be LTE (3GPP Long Term Evolution) or Wi-Fi or generally any form of wireless bearer capable of relatively high data rates to communicate IP packets. In an example system P25 is used as the LMR protocol. Other bearers may be present and participate.

Typically in an LMR network a channel is assigned to a call and the mobile end point of that call is an LMR terminal with a unique ID. Typically in an IP network over cellular the channel is shared by many mobile end points such as smart devices which have IP addresses. By converging these technologies it is necessary to associate the ID of an LMR terminal with an IP address.

An LMR system is typically Frequency Division Multiple Access (FDMA) or Time Division Multiple Access (TDMA). A channel can be defined as a frequency, frequency pair, or time slot on a frequency or frequency pair.

NZ 711325 describes a system where a multi-bearer router is used in a multi-bearer radio system that has an LMR wireless bearer and an IP wireless bearer. This router maintains tables associating the LMR radio to the base station that is currently being communicated with. Device data is established in the router having an LMR ID and an IP address for each of a plurality of multi-bearer devices in the system. Site data is also established in the router having an IP address for each of a plurality of LMR bearer base stations in the systems.

### SUMMARY OF THE INVENTION

It is an object of this invention to assist integration of LMR and IP capable paths in wireless communication systems.

In one aspect the invention resides in a method of hunting and selecting trunked control channels across LMR and IP paths and sites during mobility.

In another aspect the invention resides in a method of moving multi-bearer terminal registration in a trunked LMR system according to the best site on the system whilst roaming between sites. Measurements of signal quality are taken to identify the best site whereupon the terminal selects the best base station via the IP path. There are many ways of assessing signal quality including signal strength, bit error rate and message error rate. All methods of assessing signal quality are included in this invention though we will use signal strength as the example.

In another aspect the invention resides in a process for trunked operation for selecting a default control channel site where no RF channels are available. Said process uses an IP path to the default site.

In another aspect the invention resides in a method of terminal scanning and selecting traffic channels across LMR and IP channels. In particular, the multi-bearer terminal measures the signal quality of each site and preferentially redirects the IP path to the best base station. There are many ways of assessing signal quality including signal strength, bit error rate and message error rate. All methods of assessing signal quality are included in this invention though we will use signal strength as the example.

In another aspect the invention resides in a process for conventional operation for selecting a default traffic channel site where no RF channels are available.

### LIST OF FIGURES

Preferred embodiments of the invention will be described with respect to the accompanying drawings, of which:

FIG. 1 is an integrated LMR and IP communication system.

FIG. 2 is a Multi-bearer router (MBR).

FIG. 3 shows an overview of a trunked system containing voters.

FIG. 4 shows a possible implementation of a multi-bearer terminal.

FIG. 5 is an overview showing the multi-bearer router.

FIG. 6 shows the normal hunting problem.

FIG. 7 shows the problem of hunting with RF and IP paths available.

FIG. 8 is a sequence diagram showing a registration process via RF.

FIG. 9 is a sequence diagram showing a process of registration via IP.

FIG. 10 shows a hunting table.

FIG. 11 describes example signal levels.

FIG. 12 is the terminal flow diagram for hunting.

FIG. 13 is the MBR flow diagram for hunting.

FIG. 14 is the smart phone flow diagram for hunting.

FIG. 15 is the sequence diagram for hunting.

FIG. 16 shows registration with a default site.

FIG. 17 is the sequence diagram for registration with a default site.

FIG. 18 an illustration of Uplink voice communication using both paths.

FIG. 19 shows an illustration of Downlink voice communication using both paths.

FIG. 20 shows an example table showing routing information when moving between sites.

FIG. 21 illustrates the problem of scanning.

FIG. 22 illustrates the problem of scanning with RF and IP paths available.

FIG. 23 shows the flow diagram of a conventional scanning radio.

FIG. 24 shows the flow diagram of a conventional scanning router.

FIG. 25 shows the flow diagram of a conventional router table during mobility.

FIG. 26 shows the flow diagram of a conventional router table.

### DESCRIPTION OF PREFERRED EMBODIMENTS

Referring to the drawings it will be appreciated the invention may be performed in a variety of ways using a number of platforms that communicate LMR information across LMR RF channel and through an IP capable network. Trunked and conventional APCO Project 25 are described as the LMR systems in this example. In general terms any form of LMR could apply including Terrestrial trunked radio (TETRA), Opensky, NetworkFirst, Enhanced digital access communications system (EDACS) and Digital mobile radio (DMR). Further, the IP capable platform may be any data capable standard which can deliver relatively high data rates to enable IP communications. Examples include 3GPP standards such as LTE or LTE Advanced as well as other standards such as 3GPP2, Worldwide interoperability for microwave access (WiMAX) and Wireless local area network (WLAN).

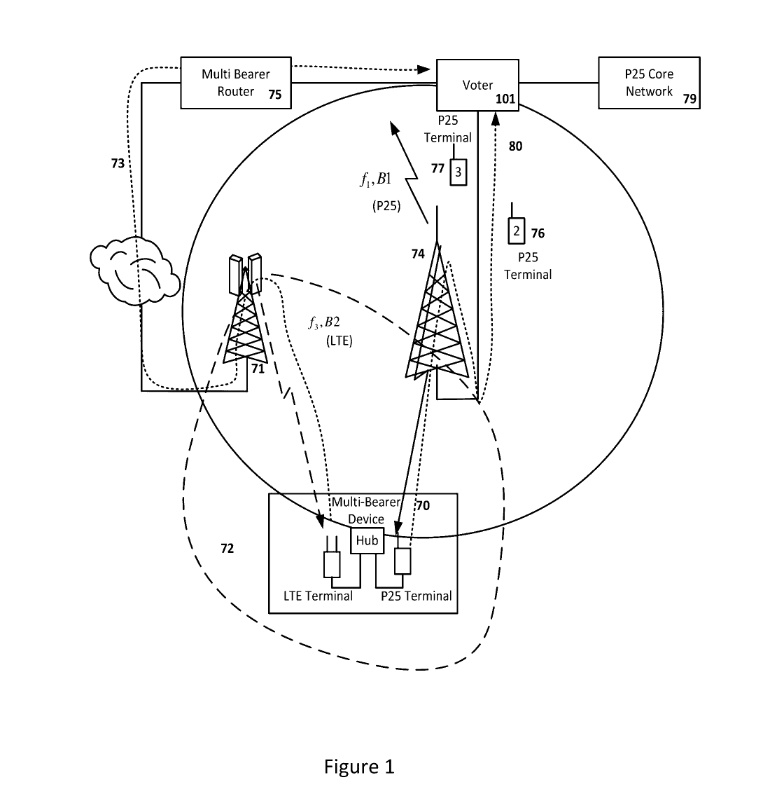

FIG. 1 illustrates the main components of a system that integrates LMR and cellular. A multi-bearer terminal 70 includes a normal P25 terminal and an LTE (or cellular) terminal connected via a processing hub capable of processing information between these units. The multi-bearer device 70 is within the coverage area of a P25 site 74 and a broadband IP site 71. In this system all multi-bearer terminals have an IP address which becomes associated with an LMR ID of the P25 terminal in a multi-bearer router 75. The multi-bearer device 70 is capable of trunked P25 operation over either standard P25 RF coverage or through an IP path which in this case is facilitated through a cellular connection. The multi-bearer device can send LMR information via standard P25 RF or through the IP path over cellular or via both. Other P25 terminals 76 and 77 or multi-bearer terminals will also usually be present.

A voter/splitter 101 is typically located within a base station associated with site 74, and is capable of receiving and selecting between multiple uplink paths, or is capable of splitting paths to send information via multiple paths on the downlink. The voter can be implemented in a number of locations. Further, the operation of the base station is controlled by a P25 trunked controller, 79 which forms part of the LMR network, and may be used for either control channel or traffic channel operation. The voter is capable of accepting multiple IP or RF inputs although only one RF and one IP pipe are described here.

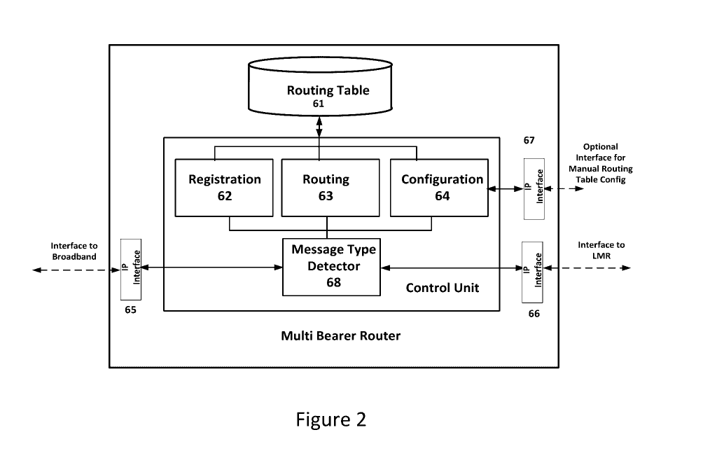

FIG. 2 shows the structure of a typical multi-bearer router 75 in FIG. 1. The router contains a processor and memory which provide various functions, enabled by software instructions and data which are stored in the memory. These functions include maintenance of a routing table 61, registration 62 of multi-bearer terminals 70, routing 63 of message packets between LMR and IP networks, and configuration 64 of these functions. Respective interfaces 65 and 66 are provided for connection to the LMR and IP networks. A further interface 67 may be provided for manual configuration of the router. A detector 68 determines whether an incoming message is in an LMR or IP protocol. Multi-bearer terminals must be registered with the multi-bearer router in order to receive messages via IP wireless signals in addition to messages which they may be receiving via LMR RF signals.

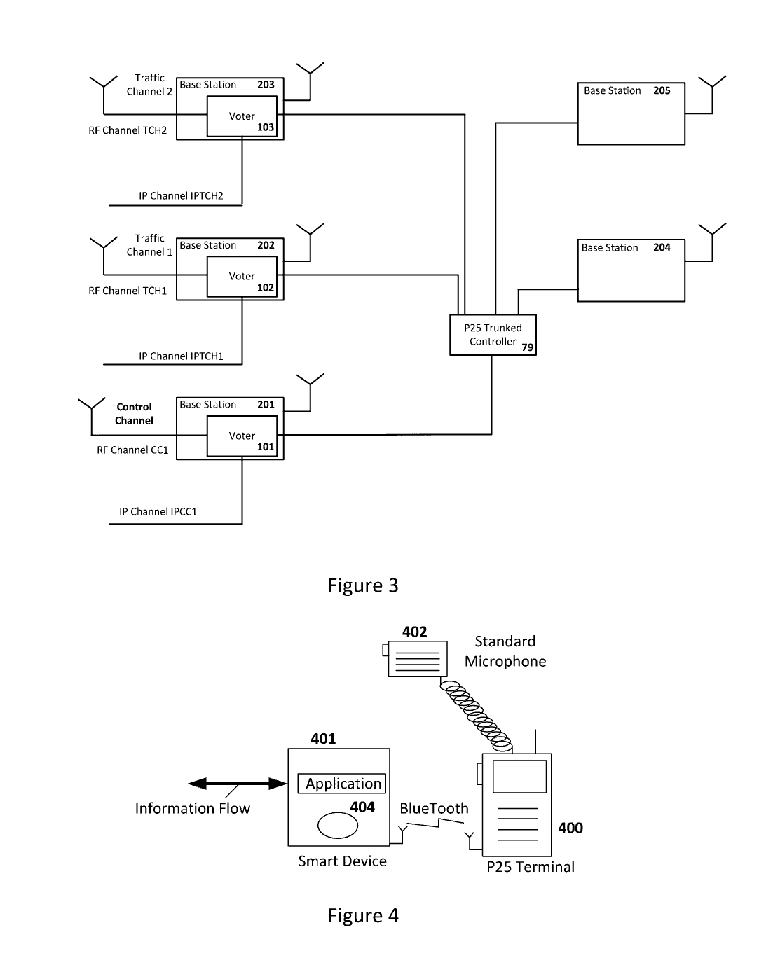

FIG. 3 shows components of a trunked P25 system. Base station 201 represents a control channel in the trunked system and contains a voter 101 which is capable of receiving messages via either a standard RF path, identified as RF control channel (CC1) or through an IP path identified as IP control channel (IPCC1). Both paths enter the voter and messages are selected to pass on to the P25 trunked controller 79. Conversely the trunked controller may send messages to the voter 101 which creates copies of each message to send over either CC1 or IPCC1.

The P25 trunked controller 79 is a central point through which all trunked calls pass. The controller is also able to control other base stations for the purpose of allocating user traffic to those channels. Base stations 202 and 203 represent examples of base stations available for traffic and would typically be present at the same site 74. Each base station contains a voter 102 and 103 respectively which are able to receive traffic via RF and/or IP paths. In the case of base station 202, these channels are identified as RF Traffic Channel (TCH1) and IP Traffic Channel (IPTCH1). On the uplink the voter 102 will select messages between each path and on the downlink it can receive messages from another source, and repeat that on both TCH1 and IPTCH1 on the downlink.

The output of the voter is the winning packets which are sent to the P25 trunked controller and may be passed on to another base station or end point elsewhere in the system whereupon the traffic is either repeated over RF or other bearers or consumed at that point.

Referring to FIG. 3, a site would typically comprise of a control channel base station and a plurality of traffic channel base stations. One example would be to say base stations 201, 202 and 203 may represent one physical site.

FIG. 4 shows one possible realisation of the Multi-bearer device 70. In this case a standard P25 terminal 400 is connected via Bluetooth to a smart device 401 which has a special hub application 404 designed to pair with the P25 terminal and preferentially process messages from the terminal. In this case a standard microphone 402 is also attached to the terminal. The multi-bearer hub can be realised in a number of ways using a number of standard interfaces including WLAN. Other examples might include using a smart microphone which pairs with the smart device. Another example may be a mobile station which uses a standard serial port to connect with a suitable processing platform that may be a smart device. A smart device containing a software P25 terminal might also be used.

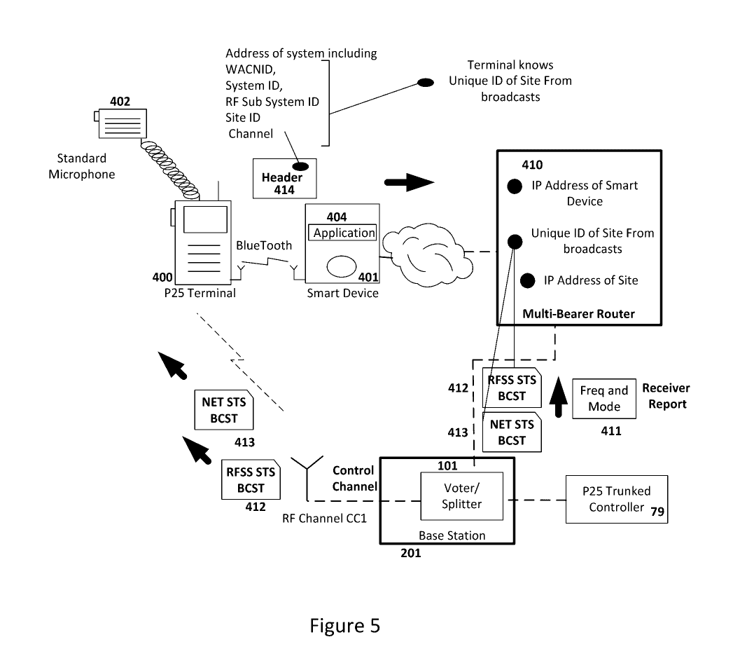

FIG. 5 shows information that is typically broadcast within a P25 system. In a typical P25 system, the following messages are broadcast over RF by the control channel CC1 via base station 201. A Network status broadcast message (NET STS BCST) and Radio frequency subsystem status broadcast (RFSS STS BCST) are broadcast by the control channel. Together they give a receiving terminal all the information needed to uniquely identify the base station from which the control channel broadcast is occurring. Identification is typically facilitated through combination of the Wide area communications network ID (WACNID), System ID, RF Sub system ID Site ID and RF Channel Number. Typically a terminal would respond by RF on the control channel frequency identified by the channel number to send messages to the control channel and through that the trunked controller 79.

If a terminal 400 is unable to respond via the RF channel then it can instead respond by an IP path facilitated through the pairing with an associated smart device 401. Key to this response however is the identification of the control channel base station 201 so that messages can be routed correctly. Preferentially, the unique ID of the control channel base station is used to create a message header 414 that the application 404 on smart device 401 can use to identify the correct control channel. This header facilitates routing of messages to the correct control channel base station. When the header is sent over the IP path then the IP address of the sender is also known. In this case it represents the IP address of the smart device. This header represents information needed to route between a terminal 400 and the control channel base station 201, including (WACNID), System ID, RF Sub System ID, Site ID, RF Channel Number. The header is stored within the application 404 operating on smart device 401. In another form, the header information could be stored within the multi-bearer router and simply referenced via the IP address of smart device 401.

The base station 201 not only sends (RFSS) and (NET) messages via RF but simultaneously sends these messages over an IP network to all other nodes on that network. This is facilitated by the voter/splitter 101 which automatically repeats signals on both RF and IP when coming from the trunked controller 79. These messages are sent by the base station over the IP network which means a receiving node acquires both the messages and the IP address of the base station 201. The multi-bearer router has the IP address of the smart device 401 associated with the terminal, the IP address and unique P25 ID of the control channel base station 201. Given this information the MBR can route messages via IP between the control channel base station 201 and the terminal 400.

A Receiver Report message is preferentially broadcast over the IP network only, in this case sent from the base station 201. This message identifies the operating frequency of the base station 201 and the mode of the base station as either Control channel or Traffic channel, and. is periodically sent by all base stations on the network. These messages are received by the MBR which is aware of the mode and frequency of each base station on the system. Focusing in particular on the mode, it means the MBR knows which of the base stations represent control channels. Given this knowledge, the MBR can listen and process only those messages emanating from the control channels or traffic channels that have been allocated for use at that time. This means the processing requirements of the MBR can be scaled according to the current level of activity on the network.

A mobile terminal regularly monitors the signal quality of each site in order to stay on the best site. Typically it is needed when the terminal is moving away from one physical site and getting closer to another. Each site in a trunked system is made up of a control channel and a plurality of traffic channels. A terminal will register with a site whereupon that site registration information is communicated to the core network (or trunked controller). When a terminal is moving out of range of one site and moving closer to another, the terminal will search for a better control channel. This process is referred to as hunting.

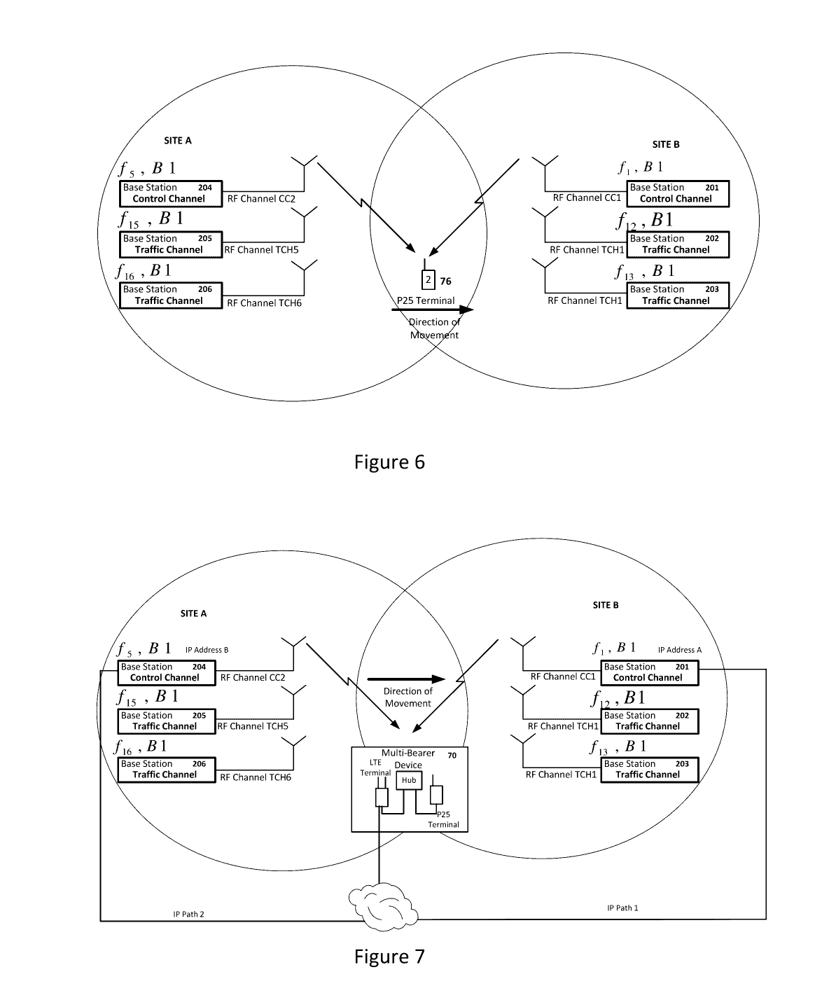

FIG. 6 offers an image that describes the normal hunting problem. One site, A, is made up of a control channel base station 204 operating on frequency f5. Also at this site are two traffic channel base stations 205 and 206 working on frequencies f15 and f16 respectively. The second site, B, is made up of a control channel base station 201 operating on frequency f1. Also at site B are two traffic channel base stations 202 and 203 operating on frequency f12 and f13 respectively.

FIG. 6 shows a P25 terminal, 76 moving from left to right. It is currently registered on control channel 204 in site A. The terminal is moving out of range of control channel 204 and getting close to control channel 201 on site B. The terminal will measure the signal strength being observed from each control channel, 201 and 204. When the signal strength is better from site B the terminal 76 will register with control channel 201 on Site B and leave control channel 204 on site A. This is normal radio operation. When an IP path is also available, however, the problem changes. In all cases the bearer B1 is P25 in these examples.

FIG. 7 shows how the system changes when a multi-bearer terminal 70 is used. There are now two paths to each base station: one RF and the other IP. The presence of two paths substantially changes the process of hunting. Terminal 70 is initially registered with site A. Specifically it is operating on control channel 204 on frequency f5. Further, terminal 70 also has an IP connection to base station 204 with IP address B. This is facilitated by the multi-bearer router (not shown).

When terminal 70 moves from left to right, it will be observing a weakening signal from control channel 204 on Site A and a strengthening signal from control channel 201 on frequency f1 on Site B. When moving between sites it is necessary that the IP connections also move. If the IP connection is not moved then the terminal ends up operating on two control channels. The terminal preferably selects control messages received by an IP path.

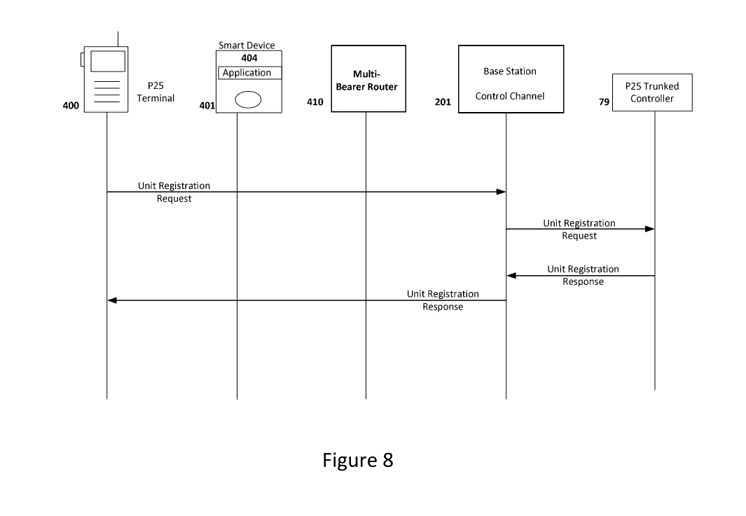

FIG. 8 shows the normal terminal registration process via RF. A terminal 400 sends a unit registration request on the carrier frequency of the control channel base station 201. It is received and passed onto the trunked controller 79. In response the trunked controller 79 sends the unit registration response back to the base station 201 which repeats it over RF and is received by the terminal 400.

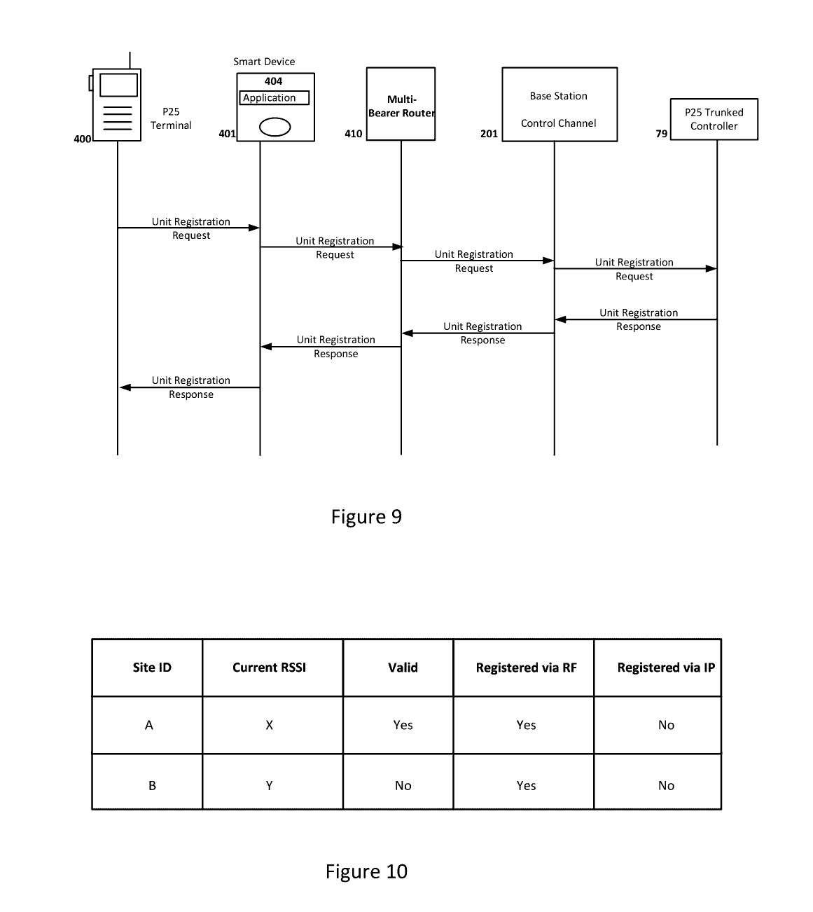

FIG. 9 shows a process by which the terminal 400 can undertake registration via the IP path. In this case the terminal has already detected (via RF) the broadcast information needed to uniquely identify the control channel base station with which it should communicate. The terminal 400 sends the unit registration request to the application 404 which is resident on the associated smart device 401. The application 404 sends an IP message to the MBR containing the unit registration request 421. Upon arrival at the MBR the message is routed to the base station 201. This routing is facilitated by a routing table in the MBR which knows the terminal ID, the IP address of the associated smart device, the IP address of the control channel base station and its P25 unique ID. Upon arrival at the base station 201, the message is passed on to the trunked controller. Upon reception of the message, the trunked controller 79 responds with a unit registration response which is routed back to the terminal via the MBR. The base station may transmit the same message by RF.

When hunting, a terminal will contain a hunting table. This hunting table contains a list of sites that have been seen within a recent time period along with a measure of signal strength used to rank (order in preference) the available sites. In the presence of an IP path this table changes.

FIG. 10 shows an example of a hunting table. The table shows how two sites A and B can be seen. The currently observed signal strength Received signal strength indicator (RSSI) from site A is X and the currently observed signal strength Received signal strength indicator (RSSI) from site B is Y.

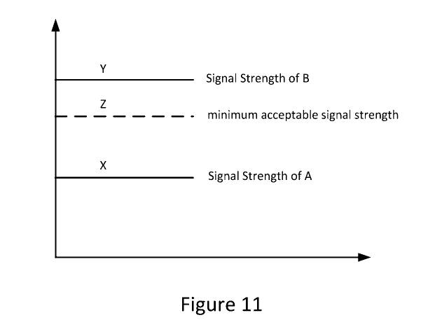

FIG. 11 shows an example of the way signal levels from site A and B are compared. The parameter Z shows the minimum acceptable signal strength for selecting a site. This parameter is typically configurable in radio systems. The parameter X shows the current signal strength from site A. In this example Site A has dropped below the minimum acceptable signal strength Z. Finally, Y represents the signal strength being observed from the site B. In this case B is stronger than both the minimum level Z and the current site X. As a result a hunting algorithm would choose site B.

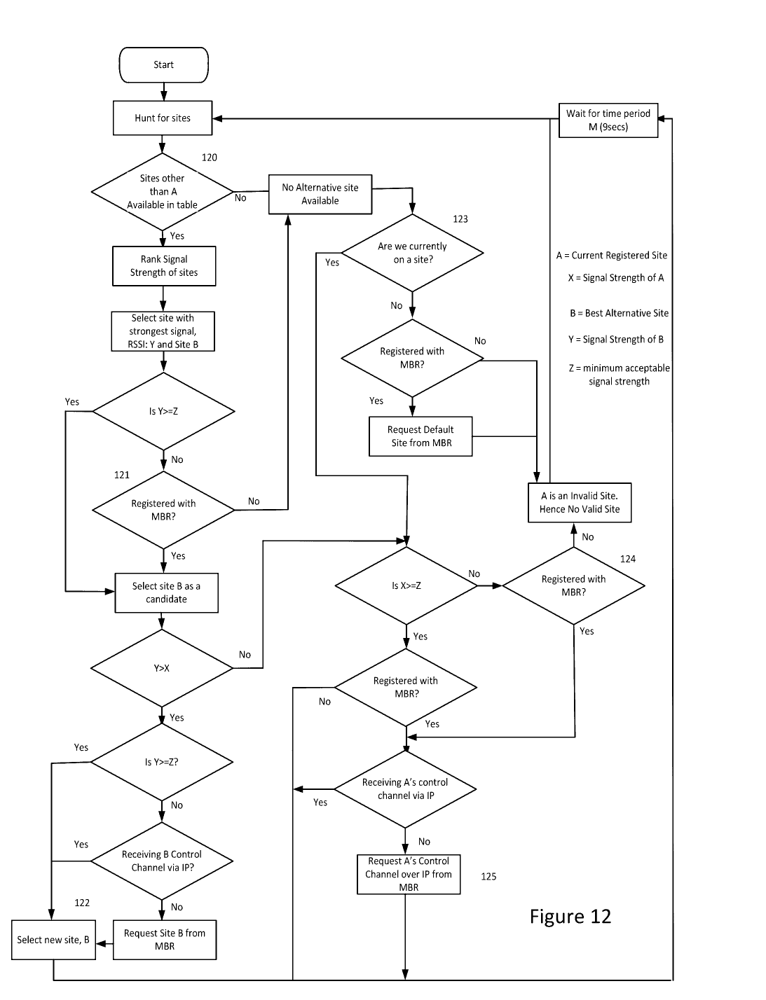

FIG. 12 is a process for hunting when control channels can be seen both via RF and via IP. Initially, the multi-bearer terminal is registered on site A. The multi-bearer radio will start by hunting for control channels. This means tuning to the known control channel frequencies and measuring the signal strength of each.

If any site other than A is being observed 120 then the sites will be ranked in order of RF signal strength and the strongest alternative is designated as site B with signal strength Y. If the signal strength Y is less than the minimum threshold then the system checks 121 to see if the radio has registered with the Multi-bearer router (MBR). If it has then it means an IP path to B may be available even though its signal strength is low. If, however, there is also no registration with the MBR then it means no alternative site is available.

If on the other hand the signal strength Y is greater than Z then it means site B is selected as a candidate alternative to A. In this case the algorithm firstly checks to see if Y is greater than the signal strength of the current site X. If this is true then another check is conducted to confirm Y is larger than the minimum required signal level Z. If true the site B is selected 122 as the new site and the terminal registers with that site. If false then it is still known that Y is greater than X which means site B is still better than site A and it probably means the terminal is moving towards site B. As a result, the next check conducted is to verify if site B control channel is being received via IP. If it is then site B is selected as the preferred site. If it is not currently being heard via IP then a request is sent to the MBR to route control traffic to this terminal whereupon B is selected.

Given the selection of the new site B the algorithm waits a period of time before starting the hunt again. A typical period of time may be 9 or 10 seconds but this is configurable.

Returning again to the top of FIG. 12, the first question posed was 120 whether or not alternatives to site A existed. If the answer is no then this triggers a set of new questions. To begin the question 123 is asked as to whether the terminal is already on a site. This is needed for example to account for the case where a radio is first switched on.

If the multi-bearer terminal is already registered with a site then a check is undertaken to see if the current signal level, X of site A is above Z. If it is then a test is conducted to see if it is registered with the MBR. If this is not the case then the algorithm simply waits for the next hunting cycle. If it is registered to the MBR then another check is made to see if the terminal is receiving control channel traffic via IP. If it is not then the request 125 is made of the MBR to receive this traffic after which the hunting cycle begins again. If it is already receiving A's control channel then again the hunting cycle simply starts again after a configurable period of time.

If on the other hand X is less than Z then a check is made to see if the terminal is registered with the MBR. If it is not registered then it means no IP path to that site is available and so A is declared an invalid site hence no sites are valid. If it is registered with the MBR then it follows the alternative path to request A's control channel via IP.

Returning again to the top of FIG. 12, if no alternative site to A exists and the terminal is not currently on a site then ordinarily that would mean it is completely out of range and so not able to operate. In this case however another option exists in that if the terminal is registered with the MBR then it can request for control channel traffic from a default site to be routed to the terminal. The default site may be a fixed or random site selection, it could be based on GPS location or it may be the last known site. Another possibility is that the terminal is directed to a virtual IP only site. This flow concludes by identifying that A is not a valid site and that at present there are no valid sites available. In the next cycle however the MBR may have responded with default site information.

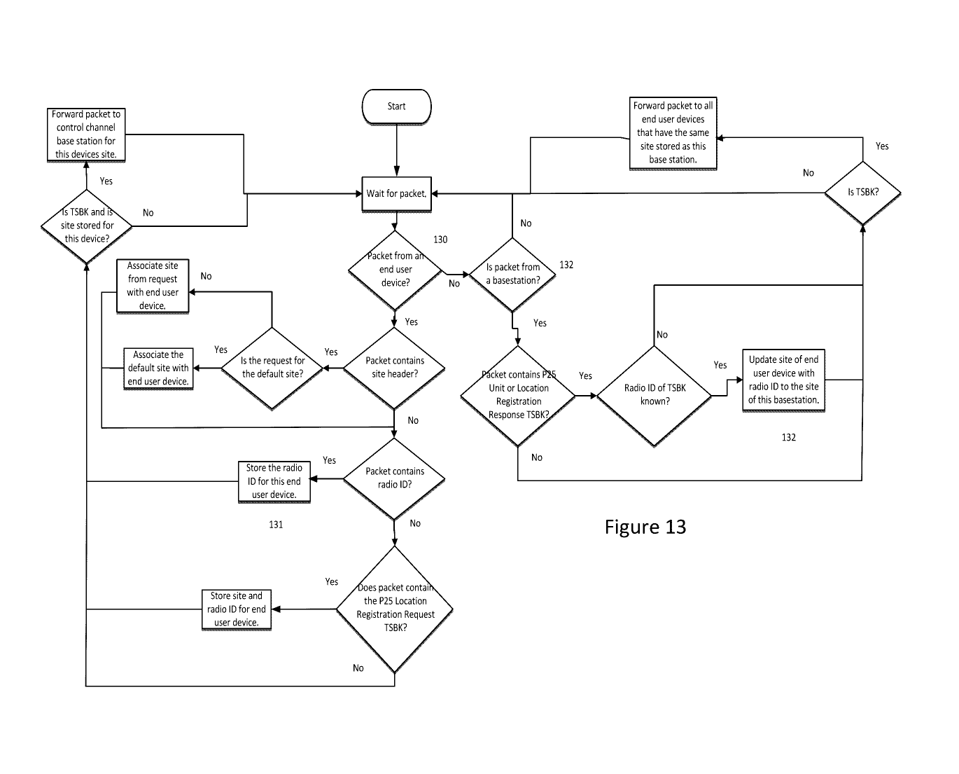

FIG. 13 shows the flow diagram for the multi-bearer router during the operation of hunting. Initially it is waiting for a packet to arrive.

If a packet comes 130 from the end user device (i.e. the multi-bearer terminal) then a number of checks are performed and action taken depending upon the message content.

If the message contains a site header then either the requested site is associated with the multi-bearer device or the default site is associated with the multi-bearer device; association being accomplished through a table update.

If the message contains a radio ID then that radio ID is stored 131 into a table. Finally, if the packet also contains a P25 location registration request then the routing table is updated associating the radio ID with the ID of the Site.

If a packet comes 132 from a base station then an alternative set of checks are performed and action taken depending upon the message content.

If the message contains a P25 unit registration response then assuming the radio ID is known in the routing table then the table is updated such that this site is associated with the radio ID.

If the message contains a P25 location registration response and assuming the radio ID is known then again the table is updated 132.

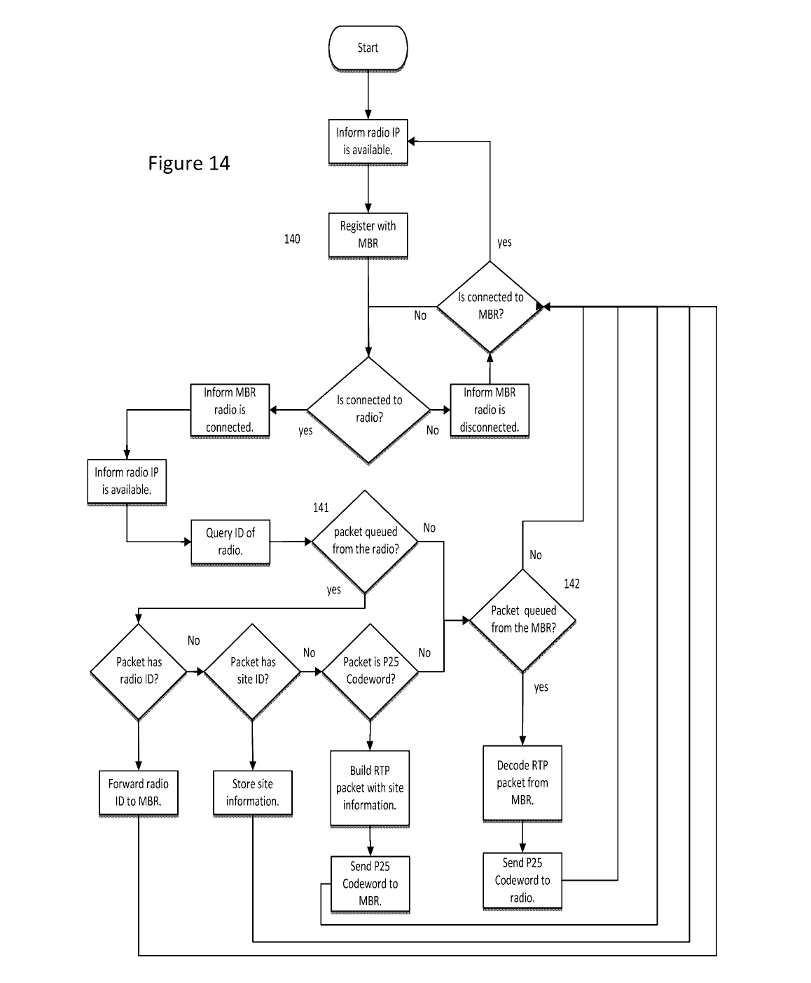

FIG. 14 shows the flow diagram for the smart device that is part of the multi-bearer terminal. Generally the smart device is used as a connection between the radio and the IP system. Initially it is assumed an IP connection is available whereupon 140 registration with the MBR takes place. The next step is to verify if the radio is connected. If it is not then the MBR is informed and following this the loop to connect and register with the MBR is repeated.

If the radio is connected to the smart phone then the MBR is informed, the radio is informed that the IP path is available and the ID is requested from the radio. If any packets are queued 141 from the radio then a sequence of checks is made. If the packet contains the radio ID then the ID is sent to the MBR. If the packet contains a site ID then it is stored locally for subsequent use. If the packet is a P25 codeword then an RTP (Real Time Protocol) packet is formed using the site information that has just been stored and the RTP message is sent onto the MBR.

If the packet does not contain a P25 codeword then another check 142 is undertaken to see if the packet has come from the MBR. If it hass then the RTP packet is decoded and the P25 codeword is sent to the radio over the IP pipe.

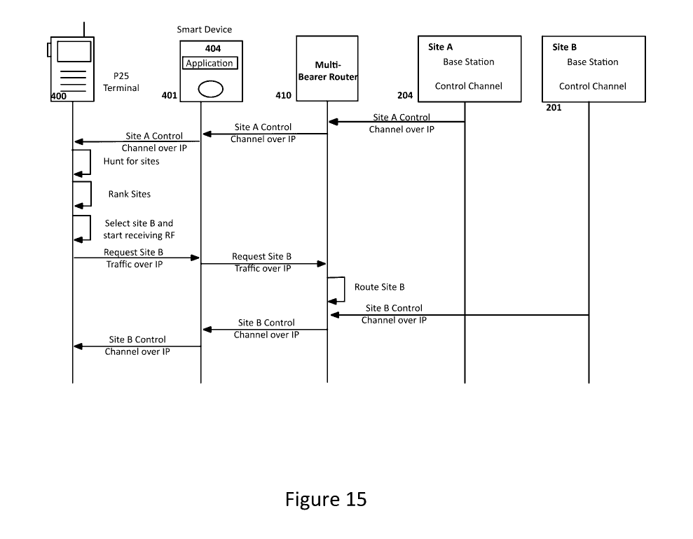

FIG. 15 shows an example sequence diagram for hunting. Initially it is assumed the terminal 400 is registered with Site A and control channel information is arriving over IP. The terminal initiates a hunt whereupon a number of channels are seen. These are ranked and a site B is selected as better than A. A request is sent to the MBR 410 to request that site B control channel is sent via IP to the terminal 400. The site B control channel is available at the MBR and is routed to the terminal 400 via the smart device 401.

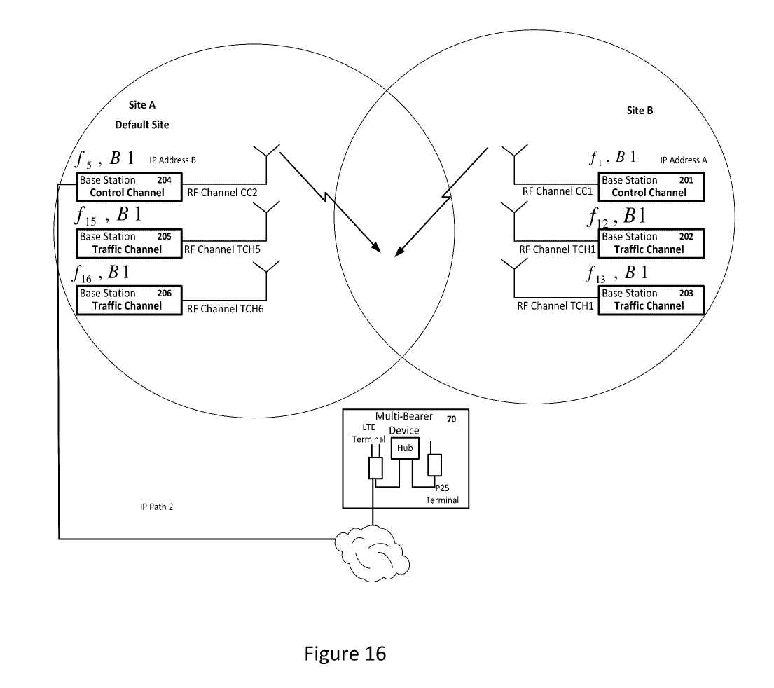

FIG. 16 shows an example of registration when a multi-bearer terminal 70 is out of range of P25 RF. In this case, the terminal does not know the address or frequency of a control channel base station with which to communicate. In this case, the terminal can still register with a default site. Specifically, the terminal will send a unit registration request to the MBR (not shown). The MBR will respond with the default site which may be a specifically designated site or the last site that the terminal was connected to. FIG. 16 highlights this example where the terminal 70 is out of range of either site A or site B. Through the MBR (not shown) the terminal is directed to a default site. In this case the default site is A using control channel 204.

FIG. 16 also highlights another aspect of the invention. In this case the multi-bearer terminal 70 is receiving solely via IP. The RF portion of the LMR terminal is available to hunt or scan. In the case of a trunked system that is observing control channel traffic over IP, the multi-bearer terminal 70 can hunt continuously for other control channels available via RF. In the case of a conventional system that is observing traffic channel information only over IP, the multi-bearer terminal 70 can continuously or periodically scan for other RF channels available.

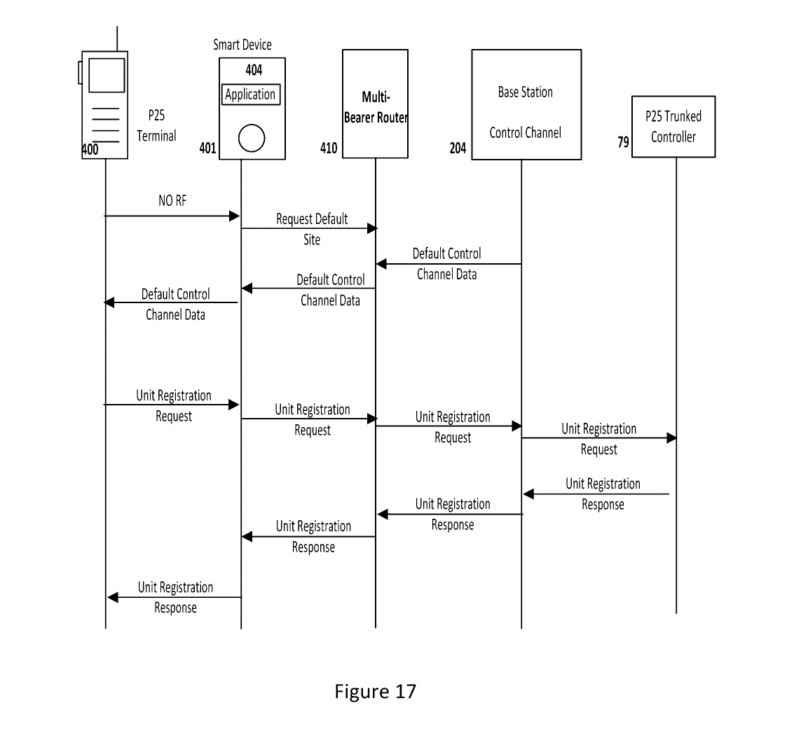

FIG. 17 builds on FIG. 16. It highlights how during registration the multi-bearer terminal has not seen any broadcast information via RF. The application 404 operating on smart device 401 will have no header prepared. In this case, the application will send a default site request directly to the MBR 410. The MBR will respond with a default control channel base station. In this case it is assumed that the default is 204. Once the terminal 400 has started receiving the control channel it will send a Unit Registration request to the smart device. The application then passes the Unit Registration request on to the MBR and finally the registration request is also passed onto the trunked controller 79 as normal. The controller responds with a unit registration response which is routed back to the terminal. The terminal is now registered via the default control channel base station even though it can see no RF channels. The MBR may also route to the last known control channel base station via which the terminal was registered. Alternatively, the MBR could use location information to identify the closest physical control channel base station to the terminal current location as a default.

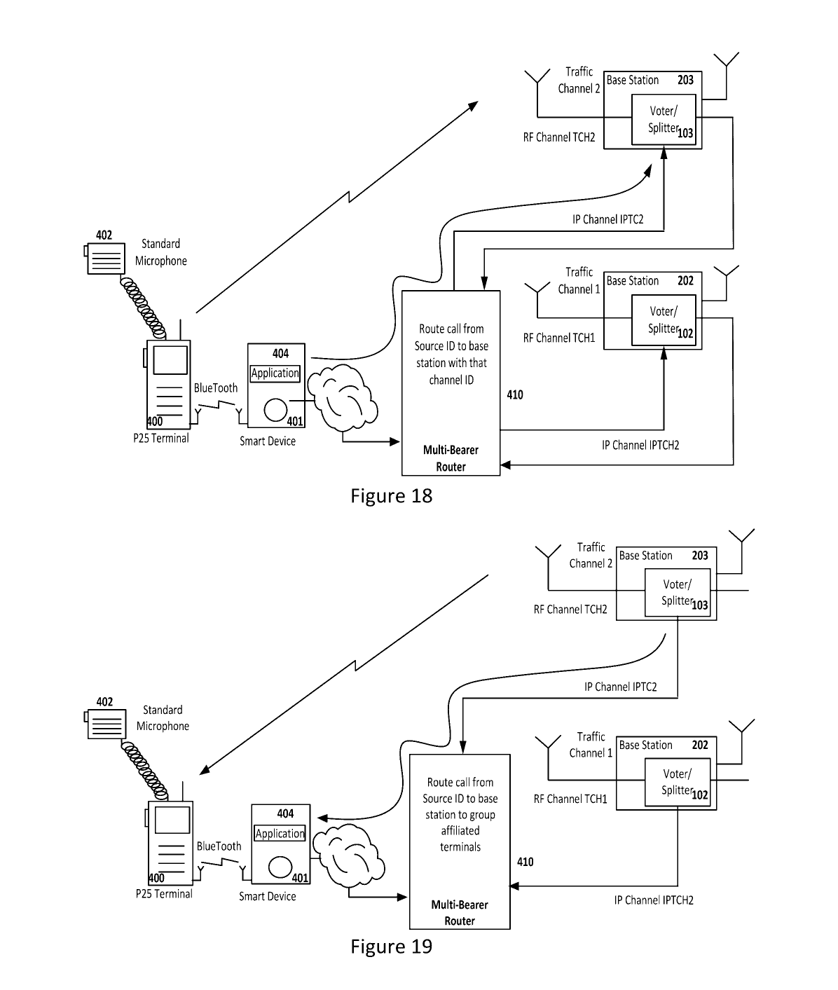

FIG. 18 illustrates the operation of a voice call on the uplink. Transmission via the RF path is normal operation. In this case the terminal has been allocated to TCH2 which is associated with base station 203. Recall however that all base stations are transmitting a Receiver Report which includes the IP address of the sender, the mode of the sender and the operating frequency of the sender. This message is received by the MBR and used to update its routing table.

Base station 203 now receives voice packets from the terminal 400 via both RF and IP path; the voter contained within the base station 203 selects the best packets from either path and sends them on to the destination. For terminals only connected via IP then the uplink destination is the MBR. The MBR will distribute information on the downlink to all members of the group.

FIG. 19 shows a voice call on the downlink path. The base station 203 is receiving voice from another source which it is assumed to be affiliated to the same group as terminal 400. The base station 203 transmits the information over the RF path as normal which means group members on the RF channel will receive it as normal. Simultaneously base station 203 sends the same information over the IP path which is received by the MBR 410. The MBR is aware of all group members and IP addresses of terminals associated with this group on this channel. It routes the voice message to all smart devices associated with the group. The application 404 on each smart device passes the voice to the associated P25 terminal.

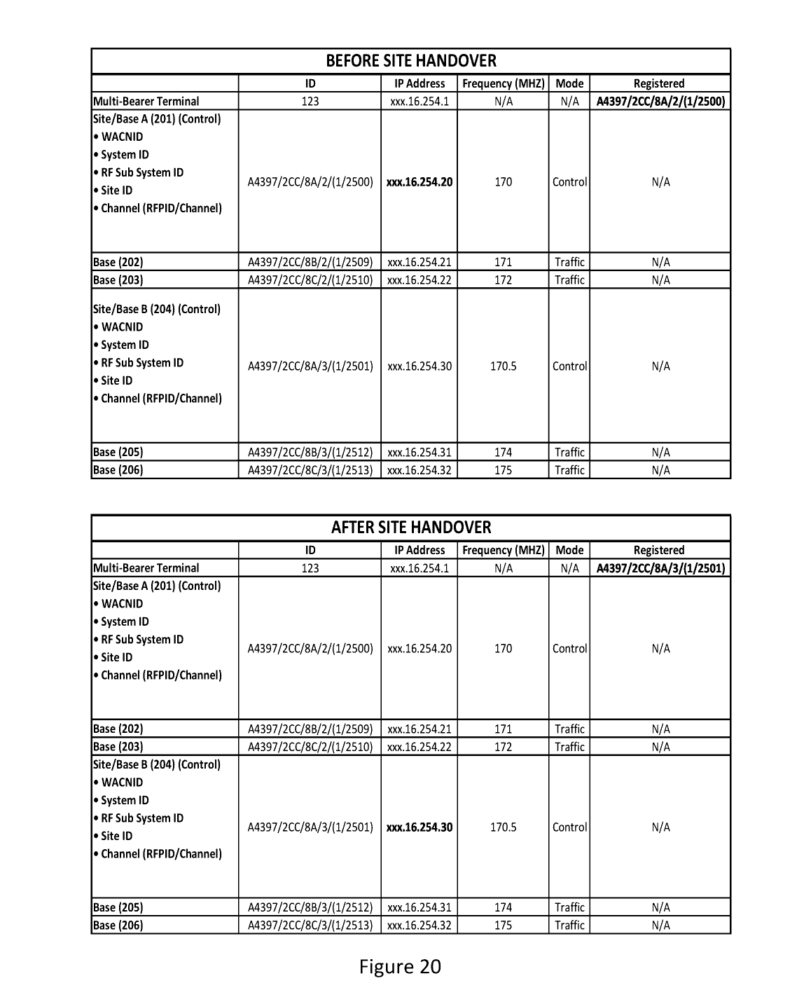

FIG. 20 illustrates an example of a routing table handover for clarity. It highlights an example before and after a handover from Site A to site B. A terminal with ID 123 is paired with a smart device with IP address xxx.16.254.1. This multi-bearer terminal is currently not in a call and is listening to the control channel from Site A which has site ID, ID A4397/2CC/8A/2/(1/2500) and IP address xxx.16.254.20. After the handover process the multi-bearer terminal will have registered with site B which has site ID A4397/2CC/8A/3/(1/2501) and IP address xxx.16.254.30.

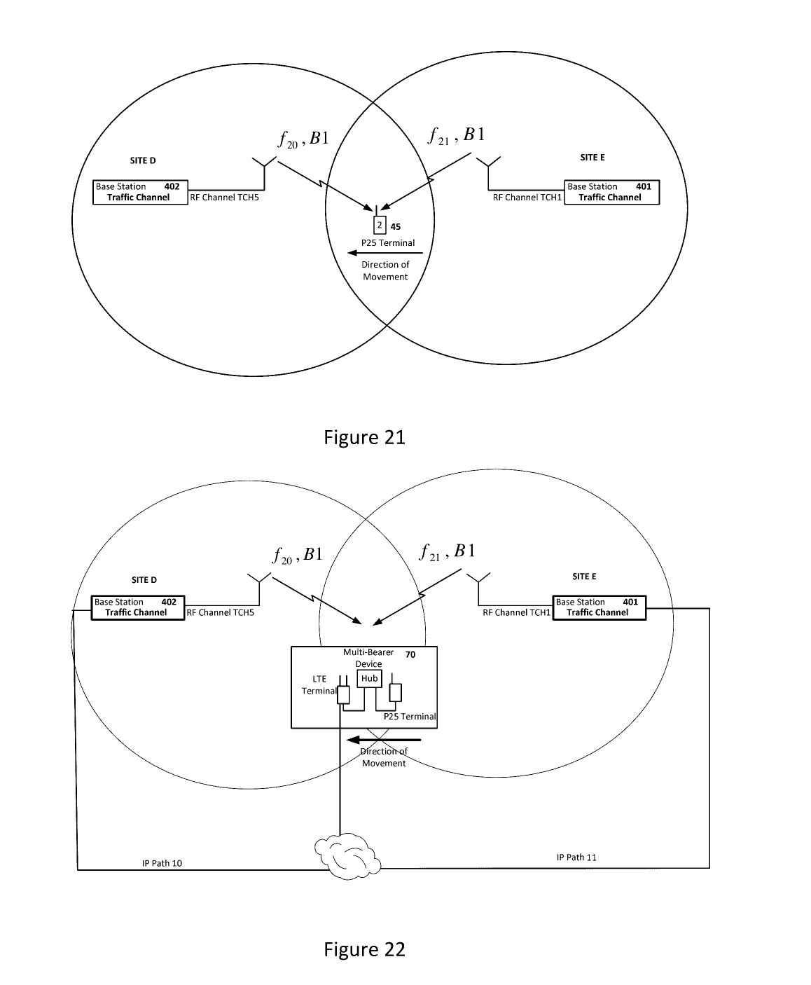

FIG. 21 indicates a scanning process in conventional radio operation. In this example site D contains a single channel operating on a downlink frequency f20 using bearer B1 which is P25. Another site E is also shown which is operating on frequency f21 also operating on P25. If a conventional call is established then the same information will be downlinked from both sites and the terminal, 45 will scan to select the best site to listen to. In the figure, terminal 45 is moving away from site E and moving closer to site D. In normal radio operation, the terminal will measure the signal strength of each site and typically at the start of a communication burst (an “over”) it will lock onto the best channel.

FIG. 22 highlights how the presence of an IP path via cellular changes the system of FIG. 21 and therefore the process. In this figure, a multi-bearer terminal is used which is capable of operating over both P25 and LTE. In this case it means that a plurality of paths exist to each of the Sites D and E. i.e. RF and IP. This means that in moving RF reception from site E to D it is preferable to move the IP paths from D to E. Whereas in the prior art the selection of a new site could only occur between overs, now the movement to the new site can be undertaken seamlessly even during an over.

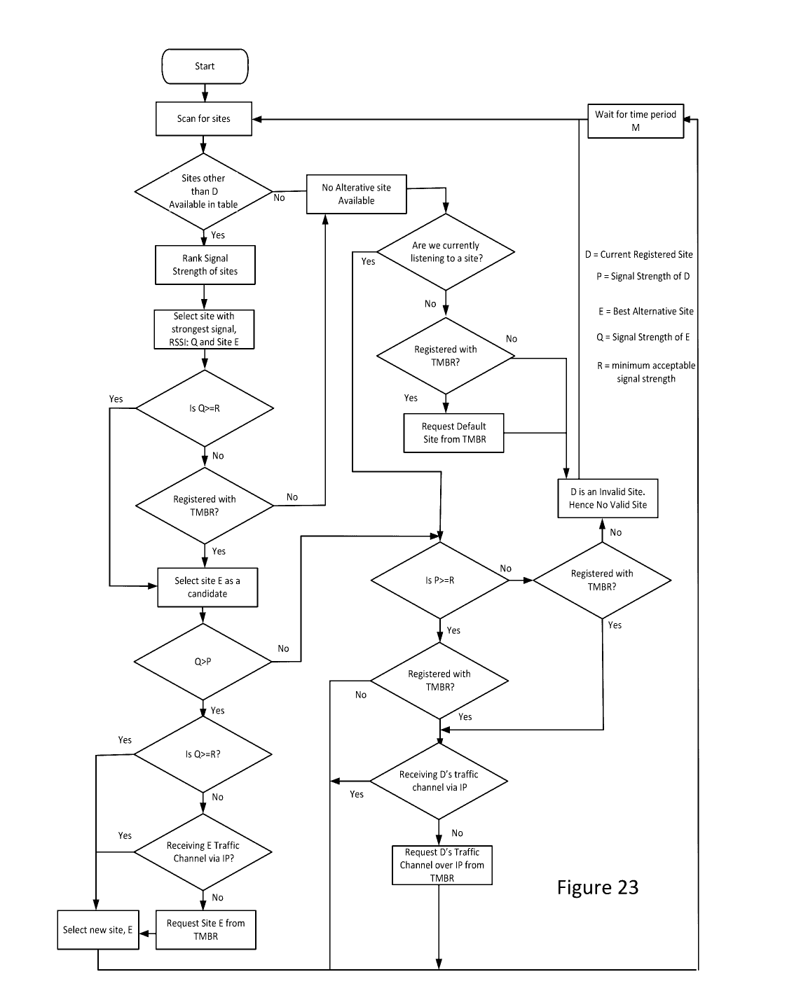

FIG. 23 shows the flow diagram for scanning when both IP and RF channels are available. The process is largely the same as that for hunting in FIG. 12. It is described in the context of site D and E (rather than A and B) and the labels for signal strength are altered to P, Q and R (rather than X, Y, Z). This change of labelling is used to highlight how the signal thresholds used may be different to the case of trunked. Apart from this however the process for scanning in conventional is the same as the process for trunked channel hunting.

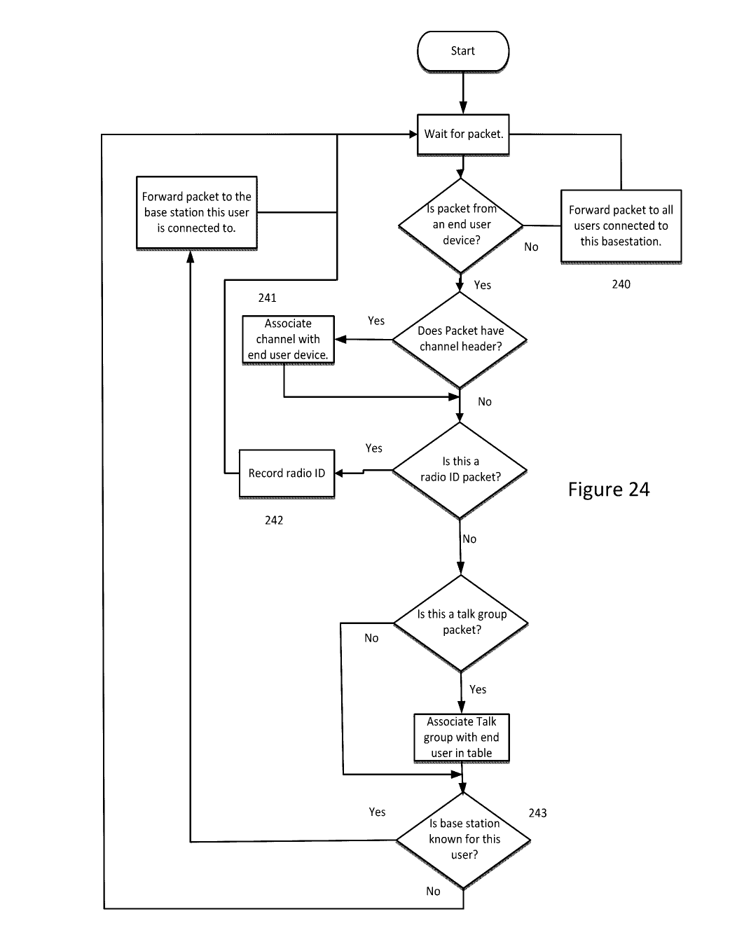

FIG. 24 shows the process for the MBR when in conventional mode. The MBR initially waits for a packet. If the packet is from a base station then it is passed on 240 to all terminals that are connected to that base station. If the packet is from a user device then a sequence of checks is made. If it contains the channel header then 241 the channel number is associated with the terminal ID in the routing table. If it contains a radio ID then 242 this ID is stored in the routing table for subsequent use as a reference to the end user device. Finally a check 243 is made to see if the end user device is associated with a base station ID. If it is then the packets are forwarded to the base station.

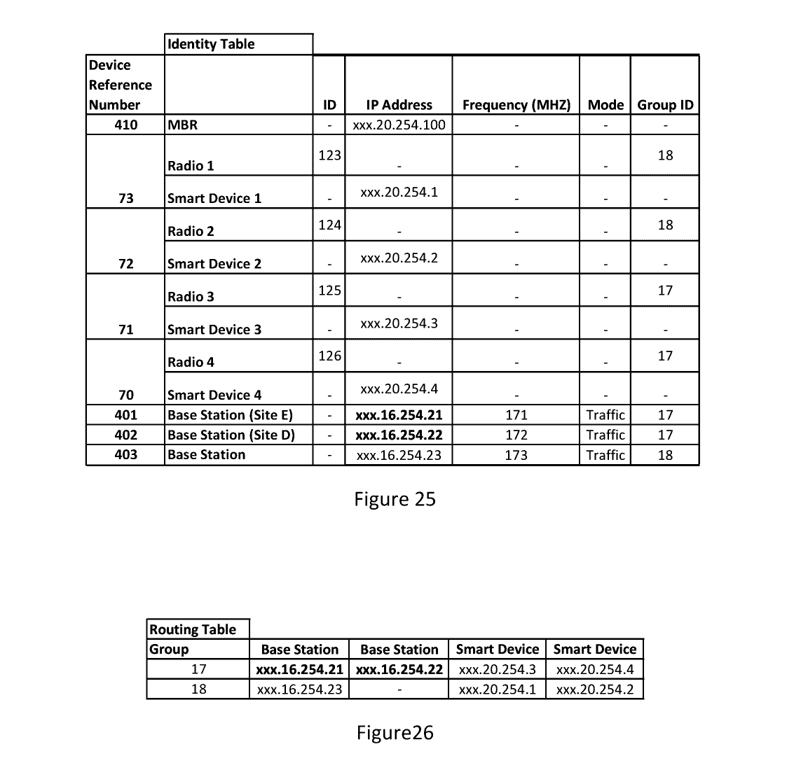

FIG. 25 illustrates a table of example device identities. In this table, it is assumed the MBR is located at IP address xxx.20.254.100. This represents a default address to which the smart devices of the multi-bearer system can communicate. One such multi-bearer system is represented by the radio 1, smart device 1 pairing identified as Radio ID 123, IP address xxx.20.254.1. Further examples include radios 2, 3 and 4 associated with smart devices 2, 3 and 4 respectively. Radio ID 123 is a member of group 18.

FIG. 25 also shows three base stations. One such example is located at IP address xxx.16.254.21 and is operating on 171 MHz for traffic and associated with Talk Group 17.

FIG. 26 illustrates a routing table with two groups 17 and 18. Each row in the table identifies the base station IP addresses associated with each Talk Group ID and the smart device IP addresses associated with each Talk Group ID.

Talk Group ID 18 is associated with a single base station operating on IP address xxx.16.254.23. This base station is operating on frequency 173 MHz. Further, the IP addresses of the smart devices associated with this group include xxx.20.254.1 which is connected to Radio ID 123 and xxx.20.254.2 associated with Radio ID 124.

Talk Group ID 17 is associated with a two base stations operating on IP addresses xxx.16.254.21 and xxx.16.254.22. These base stations operate on frequencies 171 MHz and 172 MHz respectively. The multi-bearer terminal is scanning across multiple channels. In this case both radio frequency and IP paths are available to a base station. The IP addresses of the smart devices associated with this group includes xxx.20.254.3 which is connected to Radio ID 125 and xxx.20.254.4 associated with Radio ID 126.

1. A method of operating a communication system having an LMR wireless bearer and an IP wireless bearer, including:
registering a multi-bearer terminal with a first LMR communication site,
sending control messages from the first LMR communication site to the terminal via a first RF path,
sending control messages from the first LMR communication site to the terminal via an IP path, and
selecting at the terminal between control messages sent via the RF path and control messages sent via the IP path.

2. A method according to claim 1 further including:
receiving a request from the terminal for registration at a second LMR communication site,
registering the terminal with the second LMR communication site,
sending control messages from the second LMR communication site to the terminal via a second RF path,
sending control messages from the second LMR communication site to the terminal via an IP path.

3. A method according to claim 1 further including:
receiving a request from the terminal for registration at a default LMR communication site,
registering the terminal with the default LMR communication site, and
sending control messages from the default LMR communication site to the terminal via an IP path.

4. A method according to claim 2 wherein the request for registration at the second LMR communication site is received via an IP path.

5. A method according to claim 3 wherein there is no RF path available to the terminal and the request for registration at the default LMR communication site is received via an IP path.

6. A method according to claim 3 wherein the default LMR communication site is the LMR communication at which the terminal was mostly recently registered or is the LMR communication site which is physically closest to the terminal.

7. A method according to claim 1 wherein the IP path includes a multi-bearer router which contains IP addresses for the terminal and the first LMR communication site.

8. A multi-bearer router for a communication system having an LMR wireless bearer and an IP wireless bearer, including a processor and memory, the memory containing software instructions which cause the router to:
register a multi-bearer terminal having an LMR ID and IP address,
receive a request from the terminal relating to control messages sent by a first LMR communication site,
route control messages from the first LMR communication site to the terminal via an IP path,
receive a request from the terminal relating to control messages sent by a second LMR communication site, and
route control messages from the second LMR communication site to the terminal via an IP path.

9. A multi-bearer router according to claim 8 wherein the software instruction further cause the router to:
receive a request from the terminal relating to control messages sent by a default LMR communication site, and
route control messages from the default LMR communication site to the terminal via an IP path.

10. A multi-bearer router according to claim 9 wherein the software instructions further cause the router to:
cease routing of control messages from the first LMR communication site to the terminal.

11. A method of operating a multi-bearer terminal in a communication system having an LMR wireless bearer and an IP wireless bearer, including:
communicating with a first LMR communication site via an RF path,
communicating with the first LMR communication site via an IP path,
monitoring RF signal quality from both the first LMR communication site and a plurality of other LMR communication sites,
selecting a second LMR communication site from the other LMR communication sites based on signal quality,
communicating with the second LMR communication site via an RF path,
communicating with the second LMR communication site via an IP path, and
ceasing communication with the first LMR communication site.

12. A method of operating a terminal according to claim 11 further including:
monitoring RF signal quality from both the second LMR communication site and a plurality of other LMR communication sites,
determining that RF signal quality is not sufficient for RF communication,
requesting a default LMR communication site, and
communicating with the default communication site via an IP path.

13. A method of operating a terminal according to claim 12 further including:
selecting control messages communicated from the first, second and default LMR communication site via said IP paths rather than said RF paths.

14. A method of hunting by a terminal in a communication system having an LMR wireless bearer and an IP wireless bearer, in a trunked mode, including:
communicating control channel information with a first LMR communication site via an IP path,
monitoring RF signal quality from a plurality of other LMR communication sites while communicating with the first LMR communication site,
selecting a second LMR communication site from the other LMR communication sites based on RF signal quality,
registering with the second communication site, and
communicating control channel information with the second communication site via IP or RF.

15. A method according to claim 14 further including:
requesting control channel information from the second LMR communication site via a router in the IP path.

16. A method according to claim 14 wherein the IP path includes a multi-bearer router which maintains IP addresses for the first and second LMR communication sites and for the terminal.

17. A method of scanning by a terminal in a communication system having an LMR wireless bearer and an IP wireless bearer, in a conventional mode, including:
communicating traffic with a first LMR communication site via an IP path,
monitoring RF signal quality from a plurality of other LMR communication sites while communicating with the first LMR communication site,
selecting a second communication site from the other communication sites based on RF signal quality, and
communicating traffic with the second communication site via IP or RF.

18. A method according to claim 17 further including:
requesting traffic from the second LMR communication site via a router in the IP path.

19. A method of scanning by a terminal in a communication system having an LMR wireless bearer and an IP wireless bearer, in a conventional mode, including:
communicating traffic with a first LMR communication site via IP,
detecting traffic on RF channels provided by the first LMR site while communicating with the first LMR site via IP, and
communicating traffic on an RF channel provided by the first site while communicating with the first LMR site via IP.
